(19) United States
(12) Patent Application Publication
(10) Pub. No.: US 2021/0200255 A1
(43) Pub. Date: Jul. 1, 2021

(54) HIGHER GRAPHICS PROCESSING UNIT CLOCKS FOR LOW POWER CONSUMING OPERATIONS

(71) Applicant: QUALCOMM Incorporated, San Diego, CA (US)

(72) Inventors: Srihari Babu ALLA, San Diego, CA (US); Murat Balci, San Diego, CA (US); Avinash Seetharamaiah, San Diego, CA (US); Jonnala Gadda Nagendra Kumar, San Diego, CA (US)

(21) Appl. No.: 16/729,765

(22) Filed: Dec. 30, 2019

(51) Int. Cl. G06F 1/08; G06T 1/20

(52) U.S. Cl. CPC G06F 1/08; G06T 1/20

(57) ABSTRACT

Methods, systems, and devices for processing are described. In some devices, a command processor (CP) block may determine a first workload type for processing by a graphics processing unit (GPU). The first workload type may be a low power-consuming workload type or a high power-consuming workload type. The CP block may signal a request to a graphics power management unit (GMU) of the GPU to update the upper clock rate of the GPU while processing the first workload type. The GMU may configure the upper clock rate of the GPU based on the request from the CP block and a current limit of the device, and the GPU may process the first workload type based on using the updated upper clock rate.

### BACKGROUND

The following relates generally to clock rate adjustments, and more specifically to clock rate adjustments of a graphics processing unit (GPU).

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices.

Many multimedia systems utilize a GPU to perform the processing tasks associated with the operations of the multimedia system. For example, a GPU may represent one or more dedicated processors for performing graphical operations. A GPU may be a dedicated hardware unit having fixed function and programmable components for rendering graphics and executing GPU applications. In some cases, a GPU may implement a parallel processing structure that may provide for more efficient processing of complex graphic-related operations, which may allow the GPU to generate graphic images for display (e.g., for graphical user interfaces, for display of two-dimensional or three-dimensional graphics scenes, etc.).

### SUMMARY

The described techniques relate to improved methods, systems, devices, and apparatuses for updating an upper clock rate (e.g., an upper clock rate, a peak clock rate, a performance clock rate, etc.) of a graphics processing unit (GPU) based on a processing operation of the GPU. Generally, the described techniques provide for more efficient GPU processing (e.g., while adhering to any power consumption limits, current limits, etc. associated with the device). For example, a GPU may perform processing operations based on an upper clock rate of the GPU (e.g., an operating frequency of the GPU). The GPU may process a variety of workloads associated with different workload types (high power-consuming workloads, low power-consuming workloads, etc.). As such, various processing operations may be associated with different workload types (e.g., and thus different power consumption). A command processor (CP) block of the GPU may determine a workload type associated with a processing operation and may signal, to a graphics power management unit (GMU) associated with the device, a request to update the upper clock rate of the GPU based on the determined workload type. The GMU may configure the upper clock rate of the GPU based on the request. In some examples, the CP block may directly configure the upper clock rate of the GPU based on the determined workload type (e.g., via software implementations). Accordingly, the GPU may perform the processing operation according to the configured upper clock rate of the GPU.

A method of processing at a device is described. The method may include determining, by a command processor block of a GPU, a first workload type for a first processing operation based on a first rendering operation, and signaling, from the command processor block to a graphics power management unit, a first request to update an upper clock rate of the GPU based on the determined first workload type. The method may further include configuring, by the graphics power management unit, the upper clock rate of the GPU based on the first request, and completing the first processing operation based on the configured upper clock rate of the GPU.

An apparatus for processing at a device is described. The apparatus may include a processor, memory coupled with the processor, and instructions stored in the memory. The instructions may be executable by the processor to cause the apparatus to determine, by a command processor block of GPU, a first workload type for a first processing operation based on a first rendering operation, signal, from the command processor block to a graphics power management unit, a first request to update an upper clock rate of the GPU based on the determined first workload type, configure, by the graphics power management unit, the upper clock rate of the GPU based on the first request, and complete the first processing operation based on the configured upper clock rate of the GPU.

Another apparatus for processing at a device is described. The apparatus may include means for determining, by a command processor block of a GPU, a first workload type for a first processing operation based on a first rendering operation, signaling, from the command processor block to a graphics power management unit, a first request to update an upper clock rate of the GPU based on the determined first workload type, configuring, by the graphics power management unit, the upper clock rate of the GPU based on the first request, and completing the first processing operation based on the configured upper clock rate of the GPU.

A non-transitory computer-readable medium storing code for processing at a device is described. The code may include instructions executable by a processor to determine, by a command processor block of a GPU, a first workload type for a first processing operation based on a first rendering operation, signal, from the command processor block to a graphics power management unit, a first request to update an upper clock rate of the GPU based on the determined first workload type, configure, by the graphics power management unit, the upper clock rate of the GPU based on the first request, and complete the first processing operation based on the configured upper clock rate of the GPU.

Some examples of the method, apparatuses, and non-transitory computer-readable medium described herein may further include operations, features, means, or instructions for determining one or more paths for the first processing operation based on the determined first workload type, where the upper clock rate of the GPU may be configured based on the one or more paths for the first processing operation. In some examples of the method, apparatuses, and non-transitory computer-readable medium described herein, the upper clock rate of the GPU may be configured based on one or more processing blocks associated with the one or more paths for the first processing operation.

In some examples of the method, apparatuses, and non-transitory computer-readable medium described herein, configuring the upper clock rate of the GPU based on the first request may include operations, features, means, or instructions for increasing the upper clock rate of the GPU based on the first workload type for the first processing operation, where the first processing operation may be completed based on the increased upper clock rate. Some examples of the method, apparatuses, and non-transitory computer-readable medium described herein may further include operations, features, means, or instructions for determining, by the graphics power management unit, the upper clock rate of the GPU based on the first workload type and a power condition of the device. In some examples of the method, apparatuses, and non-transitory computer-readable medium described herein, the first request may be signaled during the first processing operation of the first workload type.

Some examples of the method, apparatuses, and non-transitory computer-readable medium described herein may further include operations, features, means, or instructions for determining, by the command processor block of the GPU, a second workload type for a second processing operation based on a second rendering operation, signaling a second request to update the upper clock rate of the GPU based on the second workload type and the completion of the first processing operation, and configuring, by the graphics power management unit, the upper clock rate of the GPU based on the second request. Some examples of the method, apparatuses, and non-transitory computer-readable medium described herein may further include operations, features, means, or instructions for determining one or more paths for the second processing operation based on the second workload type, where the upper clock rate of the GPU may be updated based on the one or more paths for the second processing operation. In some examples of the method, apparatuses, and non-transitory computer-readable medium described herein, configuring the upper clock rate of the GPU based on the second request may include operations, features, means, or instructions for reducing the upper clock rate of the GPU based on the second workload type.

Some examples of the method, apparatuses, and non-transitory computer-readable medium described herein may further include operations, features, means, or instructions for queuing a first workload batch for the first processing operation, where the first request includes an interrupt signal to request the graphics power management unit to update the upper clock rate of the GPU based on the queued first workload batch. In some examples of the method, apparatuses, and non-transitory computer-readable medium described herein, the first workload type may be determined based on the first workload batch. In some examples of the method, apparatuses, and non-transitory computer-readable medium described herein, the queuing may be based on the first rendering operation.

Some examples of the method, apparatuses, and non-transitory computer-readable medium described herein may further include operations, features, means, or instructions for determining that the first workload type may be associated with a power condition that may be below a threshold, where the first request includes an indication to increase the upper clock rate of the GPU based on the determination that the first workload type may be associated with the power condition.

### BRIEF DESCRIPTION OF THE DRAWINGS

FIG. 1 illustrates an example of a system for processing that supports higher graphics processing unit (GPU) clocks for low power consuming operations in accordance with aspects of the present disclosure.

FIG. 2 illustrates an example of a device that supports higher GPU clocks for low power consuming operations in accordance with aspects of the present disclosure.

FIG. 3 illustrates an example of a GPU that supports higher GPU clocks for low power consuming operations in accordance with aspects of the present disclosure.

FIGS. 4 and 5 show block diagrams of devices that support higher GPU clocks for low power consuming operations in accordance with aspects of the present disclosure.

FIG. 6 shows a block diagram of a GPU that supports higher GPU clocks for low power consuming operations in accordance with aspects of the present disclosure.

FIG. 7 shows a diagram of a system including a device that supports higher GPU clocks for low power consuming operations in accordance with aspects of the present disclosure.

FIGS. 8 and 9 show flowcharts illustrating methods that support higher GPU clocks for low power consuming operations in accordance with aspects of the present disclosure.

### DETAILED DESCRIPTION

A processing unit, such as a graphics processing unit (GPU) may include an internal clock that sets the rate at which the GPU may perform processing operations (e.g., sets the operating frequency of the GPU). In some cases, a GPU operating at a higher maximum clock rate (e.g., a higher upper clock rate, a higher peak clock rate, a higher performance clock rate, etc.) may perform processing operations at a faster rate than a GPU operating at a lower maximum clock rate. However, operating with higher maximum clock rates may be associated with higher power consumption by the GPU (e.g., which may result in a higher power cost on a device utilizing or implementing the GPU). Similarly, the device operating the GPU at a higher maximum clock rate may provide higher current levels within the device (e.g., higher current draws from the device may be associated with operation of a GPU at higher clock rates). Further, processing different workload types may be associated with different power costs on the device. For example, the GPU of the device may process a higher power-consuming workload type at the same maximum clock rate used to process a lower power-consuming workload type, but the device may experience higher power consumption by the GPU while processing the higher power-consuming workload type than while processing the lower-power consuming workload type. Likewise, higher power-consuming workload types may result in higher current levels within the device (e.g., higher current draw by the GPU).

In some cases, the device and/or the GPU may be associated with a current limit, a power limit, a voltage limit, etc. (e.g., which may be based on a power management integrated circuit (PMIC) of the device). For example, a PMIC may implement the current limit based on a power condition (e.g., a threshold power value) of the device. For example, the PMIC may set the current limit based on a power availability of the device (e.g., the device may be in a low power mode) or based on the hardware of the device (e.g., the current limit may preserve the longevity of the hardware of the device). Additionally or alternatively, the PMIC may set the current limit based on a target power efficiency of the device.

As such, a device may be associated with a current limit and may set an upper clock rate of a GPU (e.g., a maximum clock rate of a GPU in MHz, GHz, etc.) such that the GPU (or the device) may operate below the current limit for various workload types that the GPU may process. However, the upper clock rate of the GPU may be set such that high (e.g., highest) power consuming workloads may be processed while adhering to a current limit, a power limit, a voltage limit, etc. In some cases, this may result in inefficient processing (e.g., inefficient processing timelines) for some workload types (e.g., lower power-consuming workload types) associated with a lower current draw (e.g., a lower power cost). For example, the GPU may process some lower power-consuming workload types at higher upper clock rates (e.g., a higher operating frequency of the GPU) while still adhering to some PMIC limit. Processing operations associated with lower power-consuming workload types that are performed with higher maximum clock rates may experience similar current draw (e.g., power cost) as other processing operations associated with higher power-consuming workload types performed at a lower maximum clock rate.

The techniques described herein may provide for efficient updating of upper clock rates (of a GPU) based on workload types associated with various processing operations of the GPU. In some examples, a command processor (CP) block of the GPU may monitor a workload type queued for a processing operation in order to update or configure the upper clock rate of the GPU. The CP block may determine the workload type and may identify a set of paths for the processing operation based on the workload type (e.g., as different workload types may be processed via different GPU paths, or different GPU processing blocks, depending on processing needs associated with the workload type). In some examples, the CP block may determine that the upper clock rate of the GPU may be updated (e.g., increased) based on determining the workload type (e.g., and thus the processing paths or processing blocks corresponding to the workload type) for a processing operation may be associated with reduced (e.g., lower) power consumption.

For example, the CP block may determine the workload type at the beginning of a processing operation for a number of workloads (e.g., a workload batch) associated with the workload type. The CP block may signal, to a graphics power management unit (GMU), a request to update the upper clock rate of the GPU based on the workload type and the power condition (e.g., a current limit, a power limit, a voltage limit, a PMIC limit etc.) of the device or GPU. In some cases, the CP block may directly set the upper clock rate of the GPU (e.g., in devices that may not feature a GMU) based on the workload type and the power condition of the device (e.g., via software). The GPU may perform the processing operation (e.g., process the workloads associated with the workload type) and, in some examples, the CP block may continue to monitor queued workload types for subsequent processing operations. Accordingly, at the completion of a processing operation of a first workload type, the CP may determine that the GPU may perform a second (e.g., subsequent) processing operation of a second workload type (e.g., such that the device or GPU may update the upper clock rate based on the second workload type). In some examples, the CP block may determine to update the upper clock rate of the GPU while the GPU processes the second workload type based on the second workload type and the power condition of the device.

The described techniques may provide for improvements in system efficiency as a device (e.g., a GPU of the device) may adaptively perform different processing operations (e.g., process different workload batches) at different upper clock rates (e.g., at different operating frequency, different speeds, etc.) according to workload types (high power-consuming workloads, low power-consuming workloads, etc.) associated with the different processing operations (e.g., while adhering to any power conditions, such as a current limit, set by the device). As such, the described techniques may provide for GPUs with greater processing flexibility and/or more efficient processing timelines for various workload types that the GPU may process, which may result in improved processing efficiency, reduced rendering latency, etc.

Aspects of the disclosure are initially described in the context of a multimedia system. Additional aspects are described with reference to example GPU configurations. Aspects of the disclosure are further illustrated by and described with reference to apparatus diagrams, system diagrams, and flowcharts that relate to higher GPU clocks for low power consuming operations.

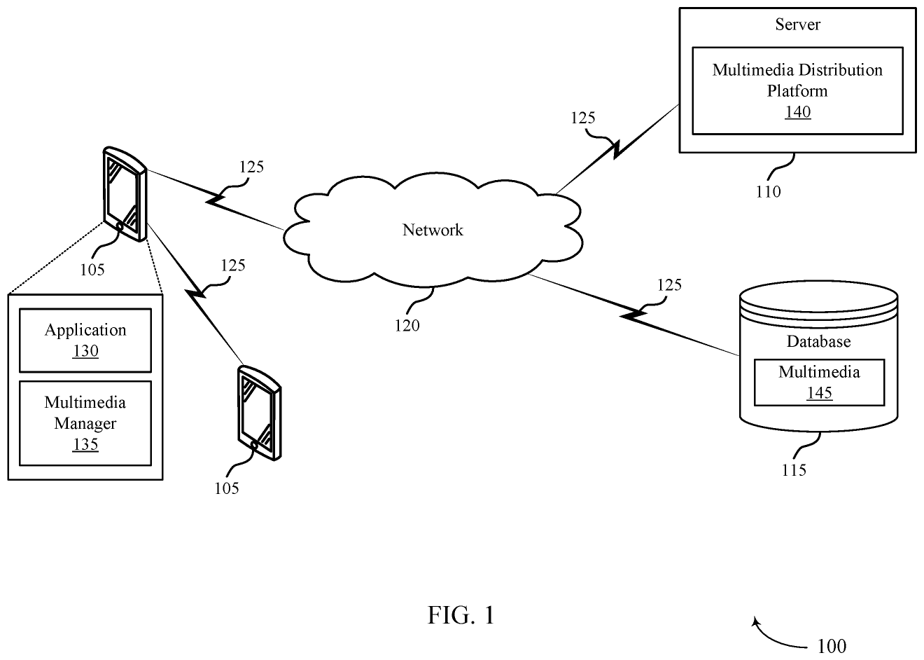

FIG. 1 illustrates an example of a multimedia system 100 that supports higher GPU clocks for low power consuming operations in accordance with aspects of the present disclosure. The multimedia system 100 may include devices 105, a server 110, and a database 115. Although, the multimedia system 100 illustrates two devices 105, a single server 110, a single database 115, and a single network 120, the present disclosure applies to any multimedia system architecture having one or more devices 105, servers 110, databases 115, and networks 120. The devices 105, the server 110, and the database 115 may communicate with each other and exchange information that supports higher GPU clocks for low power consuming operations such as multimedia packets, multimedia data, or multimedia control information, via network 120 using communications links 125. In some cases, a portion or all of the techniques described herein supporting higher GPU clocks for low power consuming operations may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130 and a multimedia manager 135. While, the multimedia system 100 illustrates the devices 105 including both the application 130 and the multimedia manager 135, the application 130 and the multimedia manager 135 may be an optional feature for the devices 105. In some cases, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125.

The multimedia manager 135 may be part of a general-purpose processor, a digital signal processor (DSP), an image signal processor (ISP), a central processing unit (CPU), a GPU, a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 135 may process multimedia (e.g., image data, video data, audio data) from and/or write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support higher GPU clocks (e.g., configurable upper clock rates) for low power consuming operations according to the techniques described herein.

The server 110 may be a data server, a cloud server, a server associated with an multimedia subscription provider, proxy server, web server, application server, communications server, home server, mobile server, or any combination thereof. The server 110 may in some cases include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device may support higher GPU clocks for low power consuming operations associated with the multimedia 145. The device 105 may retrieve the stored data from the database 115 via the network 120 using communication links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, and/or downlink transmissions, from the server 110 and the database 115 to the device 105. The wireless communications links 125 may transmit bidirectional communications and/or unidirectional communications. In some examples, the communication links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some cases, the device 105 may perform a number of processing operations associated with a number of rendering operations. In some examples, a GPU of the device 105 may perform the processing operations and each processing operation may be associated with a workload batch corresponding to a workload type. The GPU may process a workload batch according to an upper clock rate (e.g., an operating frequency of the GPU), which may correspond to a rate of processing commands, executing instructions, performing operations, etc. performed by the GPU. In some cases, a higher upper clock rate (e.g., a higher maximum clock rate) may correspond to a greater power cost (e.g., a greater current draw) on the device 105 (e.g., as the device may draw more current, consume more power, etc. in order to operate at a higher frequency or a higher speed).

The device 105 may be associated with a power condition (e.g., such as a current limit set by a PMIC of the device), and the device 105 may configure the processing operations of the GPU based on the power condition. For example, the PMIC may set a current limit for the device 105, and the device 105 may configure the upper clock rate of the GPU such that the GPU may operate below the current limit (e.g., below a power condition threshold of the device 105) while performing various processing operations.

In some cases, different processing operations may be associated with different workload types, and different workload types may be associated with different power costs (e.g., different current draws) on the device 105. For example, a first workload type may be associated with fewer processing blocks and/or lower power-consuming processing blocks and may likewise be a lower power-consuming workload type than a second workload type that may be associated with a greater number of processing blocks and/or higher power-consuming processing blocks, which may be a higher power-consuming workload type. In some cases, a lower power-consuming workload type may be associated with a lower power cost (e.g., a lower power condition or a lower current draw) than a higher power-consuming workload type. For example, the GPU may process two different workload types during two different processing operations using the same maximum clock rate, but the two processing operations may be associated with different power costs (e.g., current draws) on the device 105 based on processing two different workload types.

Accordingly, the GPU may process a first workload type (e.g., a lower power-consuming workload type) at a higher maximum clock rate than a second workload type (e.g., a higher power-consuming workload type) while maintaining the same power cost on the device 105. As such, in some example implementations described herein, the upper clock rate of the GPU may be updated based on the workload type that the GPU is processing (e.g., power consumption characteristics of the workload type, such as active processing paths, active blocks or hardware blocks, active circuitry, etc. associated with the workload type). In some examples, a CP block of the GPU may determine that the first workload type (e.g., the lower power-consuming workload type) will be processed during a first processing operation. In some cases, the first processing operation may be associated with a first rendering operation of the GPU. The CP block may signal a request to update the upper clock rate of GPU based on the first workload type. In some examples, the CP block may signal the request to a GMU of the device 105, and the GMU may accordingly update the upper clock rate of the GPU. In some other examples, the CP block may directly update the upper clock rate of the GPU (e.g., without sending a request to the GMU). For example, software of the device 105 associated with the GPU may identify (e.g., via CP block requests) workload types and may configure or update upper clock rates accordingly. In some cases, the CP block may signal or trigger a request to update the upper clock rate to the GPU, which may trigger software configuration of updating of upper clock rates.

In some examples, the GMU and/or the CPU may configure the upper clock rate of the GPU based on a request from the CP block. The GPU may perform the first processing operation (e.g., process the workload) based on the updated maximum clock rate of the GPU. For instance, the first workload type may be associated with a lower power-consuming workload type and the GPU may perform the first processing operation at a higher maximum clock rate relative to a second processing operation associated with a higher power-consuming workload type. In some examples, the GPU may perform the first processing operation while operating below the current limit (e.g., below the power condition threshold) of the device 105. In some cases, the CP block may monitor queued workload types such that the CP block may adaptively request updates to the upper clock rate of the GPU based on a number of workload types queued for processing by the GPU and the current limit of the PMIC.

As such, the techniques described herein may provide improvements in processing efficiency of the device 105. For example, by adaptively updating the upper clock rate of the GPU based on workload types during processing operations associated with each workload type, the GPU may operate at different upper clock rates for performing various processing operations. This may result in improvements in a number of operational characteristics, such as power consumption, processor utilization (e.g., DSP, CPU, GPU, ISP processing utilization), memory usage of the device 105, etc. The techniques described herein may also provide for more efficient processing timelines, reducing latency (e.g., rendering latency) associated with processing operations of the device 105.

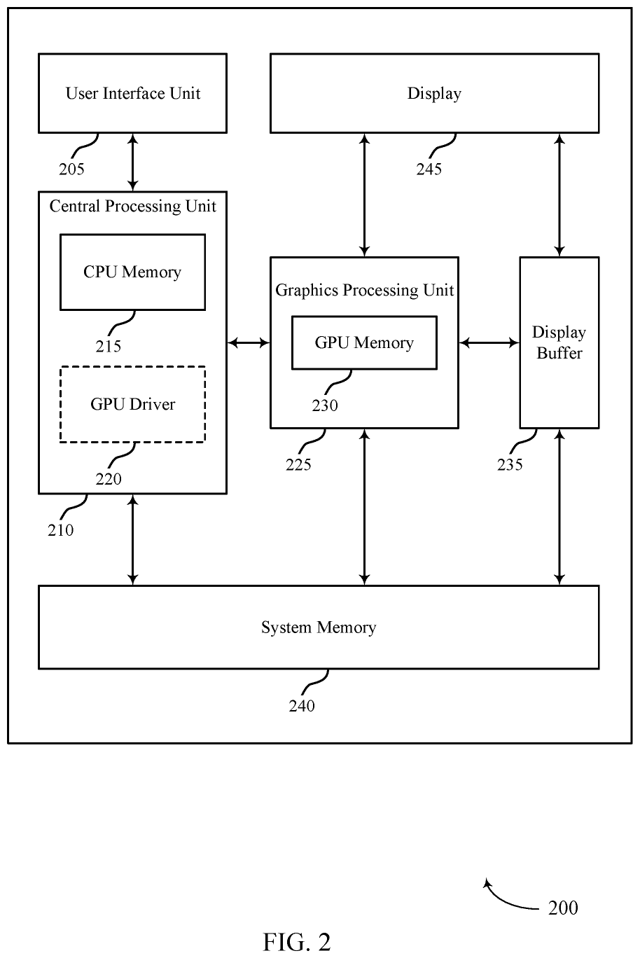

FIG. 2 illustrates an example of a device 200 in accordance with various aspects of the present disclosure. In some cases, device 200 may implement aspects of higher GPU clocks for low power consuming operations performed by a device 105 as described with reference to FIG. 1. Examples of device 200 include, but are not limited to, wireless devices, mobile or cellular telephones, including smartphones, personal digital assistants (PDAs), video gaming consoles that include video displays, mobile video gaming devices, mobile video conferencing units, laptop computers, desktop computers, televisions set-top boxes, tablet computing devices, e-book readers, fixed or mobile media players, and the like.

In the example of FIG. 2, device 200 includes a central processing unit (CPU) 210 having CPU memory 215, a GPU 225 having GPU memory 230, a display 245, a display buffer 235 storing data associated with rendering, a user interface unit 205, and a system memory 240. For example, system memory 240 may store a GPU driver 220 (illustrated as being contained within CPU 210 as described below) having a compiler, a GPU program, a locally-compiled GPU program, and the like. User interface unit 205, CPU 210, GPU 225, system memory 240, and display 245 may communicate with each other (e.g., using a system bus).

Examples of CPU 210 include, but are not limited to, a DSP, general purpose microprocessor, ASIC, FPGA, or other equivalent integrated or discrete logic circuitry. Although CPU 210 and GPU 225 are illustrated as separate units in the example of FIG. 2, in some examples, CPU 210 and GPU 225 may be integrated into a single unit. CPU 210 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 245. As illustrated, CPU 210 may include CPU memory 215. For example, CPU memory 215 may represent on-chip storage or memory used in executing machine or object code. CPU memory 215 may include one or more volatile or non-volatile memories or storage devices, such as flash memory, a magnetic data media, an optical storage media, etc. CPU 210 may be able to read values from or write values to CPU memory 215 more quickly than reading values from or writing values to system memory 240, which may be accessed, e.g., over a system bus.

GPU 225 may represent one or more dedicated processors for performing graphical operations. That is, for example, GPU 225 may be a dedicated hardware unit having fixed function and programmable components for rendering graphics and executing GPU applications. GPU 225 may also include a DSP, a general purpose microprocessor, an ASIC, an FPGA, or other equivalent integrated or discrete logic circuitry. GPU 225 may be built with a highly-parallel structure that provides more efficient processing of complex graphic-related operations than CPU 210. For example, GPU 225 may include a plurality of processing elements that are configured to operate on multiple vertices or pixels in a parallel manner. The highly parallel nature of GPU 225 may allow GPU 225 to generate graphic images (e.g., graphical user interfaces and two-dimensional or three-dimensional graphics scenes) for display 245 more quickly than CPU 210.

GPU 225 may, in some instances, be integrated into a motherboard of device 200. In other instances, GPU 225 may be present on a graphics card that is installed in a port in the motherboard of device 200 or may be otherwise incorporated within a peripheral device configured to interoperate with device 200. As illustrated, GPU 225 may include GPU memory 230. For example, GPU memory 230 may represent on-chip storage or memory used in executing machine or object code. GPU memory 230 may include one or more volatile or non-volatile memories or storage devices, such as flash memory, a magnetic data media, an optical storage media, etc. GPU 225 may be able to read values from or write values to GPU memory 230 more quickly than reading values from or writing values to system memory 240, which may be accessed, e.g., over a system bus. That is, GPU 225 may read data from and write data to GPU memory 230 without using the system bus to access off-chip memory. This operation may allow GPU 225 to operate in a more efficient manner by reducing the need for GPU 225 to read and write data via the system bus, which may experience heavy bus traffic.

Display 245 represents a unit capable of displaying video, images, text or any other type of data for consumption by a viewer. Display 245 may include a liquid-crystal display (LCD), a light emitting diode (LED) display, an organic LED (OLED), an active-matrix OLED (AMOLED), or the like. Display buffer 235 represents a memory or storage device dedicated to storing data for presentation of imagery, such as computer-generated graphics, still images, video frames, or the like for display 245. Display buffer 235 may represent a two-dimensional buffer that includes a plurality of storage locations. The number of storage locations within display buffer 235 may, in some cases, generally correspond to the number of pixels to be displayed on display 245. For example, if display 245 is configured to include 640×480 pixels, display buffer 235 may include 640×480 storage locations storing pixel color and intensity information, such as red, green, and blue pixel values, or other color values. Display buffer 235 may store the final pixel values for each of the pixels processed by GPU 225. Display 245 may retrieve the final pixel values from display buffer 235 and display the final image based on the pixel values stored in display buffer 235.

User interface unit 205 represents a unit with which a user may interact with or otherwise interface to communicate with other units of device 200, such as CPU 210. Examples of user interface unit 205 include, but are not limited to, a trackball, a mouse, a keyboard, and other types of input devices. User interface unit 205 may also be, or include, a touch screen and the touch screen may be incorporated as part of display 245.

System memory 240 may comprise one or more computer-readable storage media. Examples of system memory 240 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 240 may store program modules and/or instructions that are accessible for execution by CPU 210. Additionally, system memory 240 may store user applications and application surface data associated with the applications. System memory 240 may in some cases store information for use by and/or information generated by other components of device 200. For example, system memory 240 may act as a device memory for GPU 225 and may store data to be operated on by GPU 225 as well as data resulting from operations performed by GPU 225

In some examples, system memory 240 may include instructions that cause CPU 210 or GPU 225 to perform the functions ascribed to CPU 210 or GPU 225 in aspects of the present disclosure. System memory 240 may, in some examples, be considered as a non-transitory storage medium. The term “non-transitory” should not be interpreted to mean that system memory 240 is non-movable. As one example, system memory 240 may be removed from device 200 and moved to another device. As another example, a system memory substantially similar to system memory 240 may be inserted into device 200. In certain examples, a non-transitory storage medium may store data that can, over time, change (e.g., in RAM).

System memory 240 may store a GPU driver 220 and compiler, a GPU program, and a locally-compiled GPU program. The GPU driver 220 may represent a computer program or executable code that provides an interface to access GPU 225. CPU 210 may execute the GPU driver 220 or portions thereof to interface with GPU 225 and, for this reason, GPU driver 220 is shown in the example of FIG. 2 within CPU 210. GPU driver 220 may be accessible to programs or other executables executed by CPU 210, including the GPU program stored in system memory 240. Thus, when one of the software applications executing on CPU 210 requires graphics processing, CPU 210 may provide graphics commands and graphics data to GPU 225 for rendering to display 245 (e.g., via GPU driver 220).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 225 to execute commands without user knowledge as to the specifics of the hardware components. In order to process the graphics rendering instructions, CPU 210 may issue one or more rendering commands to GPU 225 (e.g., through GPU driver 220) to cause GPU 225 to perform some or all of the rendering of the graphics data. In some examples, the graphics data to be rendered may include a list of graphics primitives (e.g., points, lines, triangles, quadrilaterals, etc.).

The GPU program stored in system memory 240 may invoke or otherwise include one or more functions provided by GPU driver 220. CPU 210 generally executes the program in which the GPU program is embedded and, upon encountering the GPU program, passes the GPU program to GPU driver 220. CPU 210 executes GPU driver 220 in this context to process the GPU program. That is, for example, GPU driver 220 may process the GPU program by compiling the GPU program into object or machine code executable by GPU 225. This object code may be referred to as a locally-compiled GPU program. In some examples, a compiler associated with GPU driver 220 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 210 and GPU 225).

According to various aspects of the present disclosure, the GPU 225 may operate at different maximum clock rates (e.g., different upper clock rates) based on the workload type that the GPU 225 is processing. For example, a CP block of the GPU 225 may determine a first workload type associated with a first processing operation of the GPU 225 and the CP block may signal a request to update the upper clock rate of the GPU 225 during the first processing operation. In some cases, the CP block may identify the workload type from the GPU memory 230.

For example, the CP block of the GPU 225 may identify a workload batch associated with an API workload type (e.g., compute workloads, compute only, visibility pass workloads, two-dimensional (2D) block transfer (Blt) workloads, resolve engine Blt workloads, Blt/copy only, three-dimensional (3D) render workloads, 3D graphics only, etc.). In some cases, a workload type may be associated with a power condition (e.g., a low power condition, a high power condition, etc.), which may be based on the processing path (e.g., the one or more processing pipelines, processing blocks, active hardware or circuitry, etc.) used by the GPU 225 for a processing operation. For example, a low power-consuming workload type may be associated with a low power condition. In some cases, a lower power-consuming workload type may be associated with a processing path that includes fewer processing blocks and/or lower power-consuming processing blocks relative to a processing path of a higher power-consuming workload type (e.g., which may be associated with a higher power condition).

In some cases, the power condition associated with a workload type may be associated with a power cost (e.g., a current draw) on the device 200. For example, a workload type associated with a lower power condition may be associated with a lower power cost (e.g., a lower current draw) than a workload type associated with a higher power condition. For instance, the GPU 225 may process two different workload types at the same maximum clock rate, but the GPU 225 may experience two different current draws based on processing two different workload types.

The GPU 225 may process a workload type based on an upper clock rate (e.g., an operating frequency) of the GPU 225. In some cases, the processing speed, processing efficiency, etc. of the GPU 225 may depend on the upper clock rate of the GPU 225. For example, a GPU 225 may perform processing operations at a faster rate (e.g., may process more commands per second) while operating at a higher maximum clock rate than while operating at a lower maximum clock rate. However, in some cases, processing a workload at a higher maximum clock rate may be associated with a greater power cost and may likewise increase the current draw on the device 200. In some cases, the GPU 225 and/or the device 200 including the GPU 225 may be associated with a current limit (e.g., a power condition), which may be set by a PMIC of the device 200. Accordingly, the GPU 225 may be configured to operate at maximum clock rates based on the current limit (e.g., the power condition) of the device 200. For example, the GPU 225 may be configured to operate at maximum clock rates that correspond to a current draw below the current limit set of the device 200.

As such, the current draw of the GPU 225 may be based on the upper clock rate of the GPU 225 and the workload type that the GPU 225 is processing. Accordingly, components of the GPU 225 may adaptively update the upper clock rate of the GPU 225 based on processing different workload types. In some examples, the GPU 225 may update its maximum clock rate for each workload type such that the current draw of the GPU 225 may more efficiently use available power (e.g., current) from the device 200 without exceeding the current limit of the device 200. For example, some devices may restrict the upper clock rate to a single rate for all workload types (e.g., a traditional device may restrict the GPU 225 to run at the upper clock rate of a single chip, such as an SVS), which may result in the inefficient use of the power capability of the device 200 while the GPU 225 is processing a low power-consuming workload type. For instance, some workloads, such as Blts, resolve, un-resolve, and visibility pass may be associated with a lower power condition and the GPU 225 may process these example workloads at a higher maximum clock rate while still operating within the PMIC current limits of the device 105. In some specific implementations, the device 200 may run at the upper clock rate of one chip (e.g., SVS) while processing high power-consuming workload types, but may switch to an upper clock rate of a second chip (e.g., Turbo_L1) while processing low power-consuming workload types.

Example implementations of the present disclosure may enable the device 200 to adaptively update the upper clock rate of the GPU 225 based on the workload type that the GPU 225 is processing and the current limit of the device 200. This may result in more efficient use of the power capability of the device 105 and may allow the GPU 225 to perform processing operations according to faster processing timelines (e.g., based on increasing the upper clock rate of the GPU 225 while processing a low power-consuming workload type).

In some examples, a CP block of the GPU 225 may determine the workload type that the GPU 225 is processing based on a rendering mode (e.g., a rendering operation) associated with the GPU 225. The CP block may be at the front end of the GPU 225 and may signal a request (e.g., an interrupt signal) to a GMU associated with the GPU 225, and the GMU may update the upper clock rate of the GPU 225 based on the request, the determined workload type, and/or the current limit of the device 105. Additionally or alternatively, the CP block may directly update the upper clock rate of the GPU 225 (e.g., without using the GMU). For example, the CP block may atomically communicate with a frequency driver and/or a bus driver associated with the clock management of the GPU 225. In some examples, the CP block may signal the request (e.g., the interrupt signal) to the CPU 210, and the CPU 210 may handle the clock management and may accordingly update the upper clock rate of the GPU 225. In some additional or alternative examples, the CP block may use software associated with the GPU 225 to signal the request to update the upper clock rate. For example, the software may signal the request to the CP block and the CP block may pass the request along to the GMU and/or the CPU 210. Additionally or alternatively, the CP block may signal the request, via the software, to the CPU 210. For instance, the CP block may transmit an interrupt signal, using the software, to the CPU 210 and the CPU 210 may handle the clock management.

Additionally or alternatively, the device 200 may configure the upper clock rate of the GPU 225 based on a clock voting. The clock voting may be saved and/or restored based on a preemption (e.g., based on the interrupt signal). For example, preemption may save and/or restore the clock voting. In some examples, a voting mechanism may be used (e.g., by the software) to update the upper clock rate of the GPU 225. In such examples, the CP block, using the software and/or the voting mechanism, may directly update the upper clock rate of the GPU 225 (e.g., without signaling the GMU). For instance, the CP block may directly communicate, via the voting mechanism, to a frequency and/or bus driver of the GPU 225 to update the upper clock rate without signaling the GMU.

Accordingly, the CPU 210, the GMU of the GPU 225, the CP block of the GPU 225, or a combination thereof, may configure the upper clock rate of the GPU 225 based on the workload type that the GPU 225 is processing and the current limit associated with the device 105. In some examples, the CP block may determine that a first workload type (e.g., associated with a workload batch of similar workloads) is a low power-consuming workload type and may signal a first request (e.g., a first interrupt signal) to increase the upper clock rate of the GPU 225. In some implementations, the CP block may signal the first request while processing the first workload type. In some examples, the CP block may determine that the first workload type is associated with a first processing path (e.g., a first processing pipeline) including fewer processing blocks and/or lower power-consuming processing blocks and, accordingly, may determine that the first workload type is a low power-consuming workload type. The CPU 210, the GMU of the GPU 225, the CP block of the GPU 225, or a combination thereof, may increase the upper clock rate of the GPU 225 based on receiving the first request. Accordingly, the GPU 225 may process the first workload type based on the higher maximum clock rate (e.g., the GPU 225 may process the low power-consuming workload type at a higher maximum clock rate).

In some examples, upon completion of processing the first workload type, the CP block may determine a second workload type is queued for a second processing operation, where the second workload type is a higher power-consuming workload type than the first workload type. For example, the CP block may determine that the second workload type is associated with a second processing path (e.g., a second processing pipeline) including a greater number of processing blocks and/or higher power-consuming processing blocks relative to the first workload type and, accordingly, may determine that the second workload type is a higher power-consuming workload type. Accordingly, the CP block may signal a second request (e.g., a second interrupt signal) to decrease the upper clock rate of the GPU 225. The CPU 210, the GMU of the GPU 225, the CP block of the GPU 225, or a combination thereof, may decrease the upper clock rate of the GPU 225 based on receiving the second request. Accordingly, the GPU 225 may process the second workload type at a lower maximum clock rate than the GPU 225 used to process the first workload type. In some implementations, the CP block may signal the second request while processing the second workload type.

In this manner, the CP block may adaptively update the upper clock rate of the GPU 225 based on the workload type that the GPU 225 is processing (e.g., based on which processing blocks and/or paths of the GPU 225 are active) while maintaining the operation of the GPU 225 within the current limit set by the PMIC of the device 105. Based on adaptively updating the upper clock rate of the GPU 225, the GPU 225 may operate at maximum clock rates based on which processing blocks and/or paths of the GPU 225 are active. In some examples, this disclosure may be implemented in GPUs 225 featuring multi-pipe capabilities and/or GPUs 225 featuring concurrent binning capabilities (e.g., such as in A7X). In some examples, aspects of the present disclosure may be implemented in various products (e.g., such as, for example, SDM865 products).

The CP block may determine that a workload type is associated with a power condition and may categorize the workload type in a variety of different ways. In some examples, the CP block may categorize the workload type based on the power condition associated with the workload type. For example, the CP block may categorize workload types into a number of discrete categories, where a category may be associated with an upper clock rate or an operating frequency that the GPU 225 may operate at while processing workload types within the category. As such, aspects of the techniques described herein may generally be applied to any number of workload type categories (e.g., and any number of corresponding upper clock rates) by analogy, without departing from the scope of the present disclosure.

In a first example implementation, the CP block may categorize workload types into two categories, where a first category may be associated with lower power-consuming workload types (e.g., workload types associated with a power condition below a threshold value) and a second category may be associated with higher power-consuming workload types (e.g., workload types associated with a power condition above a threshold value). In a second example implementation, the first category may be associated with lower power-consuming workload types and the second category may be a default category including a number of other workload types. In some examples, the GPU 225 may process workload types within the first category using a higher maximum clock rate (e.g., using Turbo L1) and the GPU 225 may process workload types within the second category using a lower maximum clock rate (e.g., using SVS). Additionally or alternatively, the CP block may determine an upper clock rate for each workload type based on the power condition of the workload type, and, for each workload type, the CP block may signal a request to update the upper clock rate of the GPU 225 based on the particular power condition of the workload type and the current limit of the device 105.

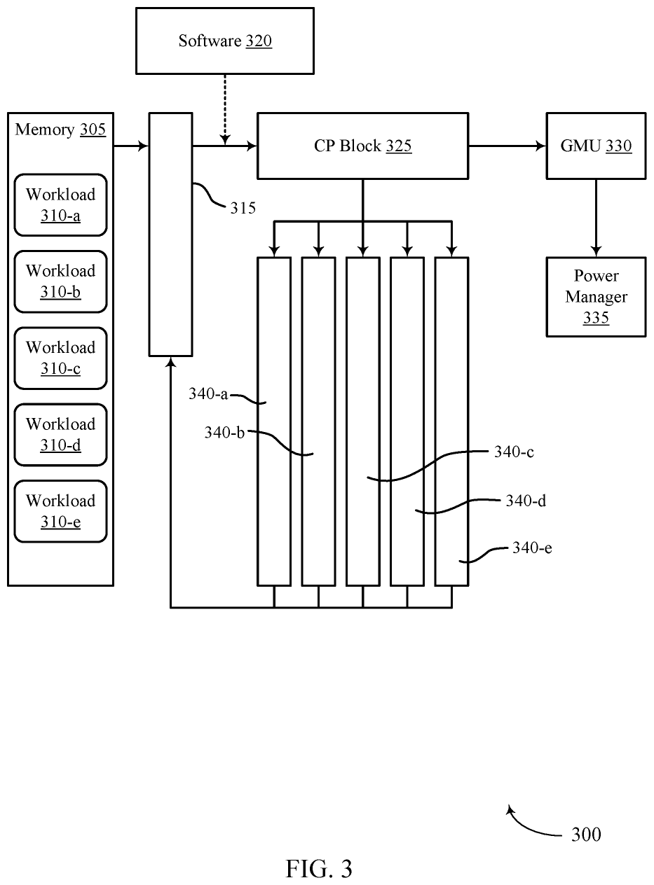

FIG. 3 illustrates an example of a GPU 300 that supports higher GPU clocks for low power consuming operations in accordance with aspects of the present disclosure. In some examples, GPU 300 may implement aspects of multimedia system 100 and may be an example of GPU 225 as described in FIGS. 1 and 2. GPU 300 may process a workload type based on the power condition (e.g., power consumption, current draw, etc.) of the workload type and based on the current limit of the device including the GPU 300, such as a device 105 as described in FIG. 1. GPU 300 may support more efficient processing timelines by adaptively updating its maximum clock rate based on the workload type the GPU 300 is processing.

In some examples, GPU 300 may include memory 305, which may further include a number of workloads 310. For example, memory 305 may include workload 310-a, workload 310-b, workload 310-c, workload 310-d, and workload 310-e. In some cases, the workloads 310 may correspond to one or more of a compute workload, a compute only workload, a visibility pass workload, a 2D Blt workload, a resolve engine Blt workload, a Blt/copy only workload, a 3D render workload, a 3D graphics only workload, etc.

GPU 300 may include a system memory management unit (SMMU) 315. In some cases, SMMU 315 may be an example of a memory interface block (VBIF). SMMU 315 may transmit or otherwise enable the passage of workloads 310 from the memory 305 to a CP block 325. In some examples, CP block 325 may be in electronic communication with software 320. The CP block 325 may queue workload batches from the memory 305 for processing by a processing path 340, which may also be known as a processing pipeline. In some cases, each of workloads 310 may correspond to a different processing path 340. For example, GPU 300 may process workload 310-a with processing path 340-a, workload 310-b with processing path 340-b, workload 310-c with processing path 340-c, workload 310-d with processing path 340-d, and workload 310-e with processing path 340-e.

Although illustrated in FIG. 3 as parallel processing paths 340, processing paths 340 may not always be parallel and, in some cases, may be interconnected. Processing paths 340 may generally include any number of processing blocks (e.g., processing elements, circuitry, hardware blocks, etc.), which in some cases may be shared between processing paths 340 (e.g., in either a parallel or serial manner). For example, processing path 340-a and processing path 340-b may share a number of processing blocks. Generally, any of workloads 310 may be processed via any combination of processing paths 340 (e.g., and in some cases, power consumption characteristics of a workload type may depend on the processing path(s) 340 implemented to execute one or more workloads 310).

For example, as discussed herein, GPU 300 may represent one or more dedicated processors for performing graphical operations. GPU 300 may be a dedicated hardware unit having fixed function and programmable components for rendering graphics and executing GPU applications. In some cases, GPU 300 may implement a parallel processing structure that may provide for more efficient processing of complex graphic-related operations. For example, GPU 300 may include a plurality of processing elements that are configured to operate in a parallel manner, which may allow the GPU to generate graphic images for display (e.g., for graphical user interfaces, for display of two-dimensional or three-dimensional graphics scenes, etc.). As described herein, various processing operations may utilize different combinations of processing elements (e.g., for various paths 340, pipelines, blocks) for execution of various workloads 310 (e.g., where different combinations of processing elements may be associated with different power consumption characteristics, may be implemented with different upper clock rates, etc.).

In some examples, workloads 310 may refer to instructions for executing or processing such workloads 310. In some examples, a processing operation may refer to processing of one or more workloads 310. GPU 300 (e.g., CP block 325) may determine a workload type for such a processing operation based on power consumption characteristics associated with the one or more workloads 310 (e.g., based on active processing paths, active blocks or hardware blocks, active circuitry, etc. associated with the one or more workloads 310). In some cases, the workload type may be identified based on a rendering operation associated with the processing operation (e.g., where, in some cases, the rendering operation may refer to identification or execution of some instructions that call or trigger the processing operation of the one or more workloads 310). In some cases, a rendering operation may call or trigger a processing operation (e.g., processing of one or more workloads 310).

For example, the CP block 325 may determine a processing path 340 that may be used to process a workload 310 and may determine a power condition (a low power condition, a high power condition, etc.) associated with the workload 310 based on the processing path 340 used to process the workload 310. For example, a workload 310 associated with a low power condition may correspond to a processing path 340 including fewer processing blocks and/or lower power-consuming processing blocks. Accordingly, a workload 310 associated with a low power condition may be a low power-consuming workload type.

In some examples, the CP block 325 may identify that a workload 310-a may be processed by the GPU 300 during a first processing operation based on a first rendering operation of the GPU 300. For example, the CP block 325 may identify that the workload 310-a is queued for a processing path 340-a. In some aspects, the CP block 325 may queue workload 310-a based on the second rendering operation. Based on the processing path 340-a associated with the workload 310-a (e.g., based on which processing path 340 is active during the processing of the workload 310-a), the CP block 325 may determine that the workload 310-a is associated with a first workload type (e.g., a low power-consuming workload type, a high power-consuming workload type, etc.). In some aspects, the workload 310-a may be associated with a workload batch, where all workloads 310-a within the workload batch may be associated with the same workload type.

In some implementations, the CP block may determine the first workload type of the workload 310 and may determine that the upper clock rate of the GPU 300 may be updated based on the first workload type. For example, as described herein, the device 105 may be associated with a power condition (e.g., a maximum current draw or a current limit), such that the GPU 300 may operate at maximum clock rates that result in a current draw that is less than the current limit of the device 105. In cases when the CP block 325 determines that the upper clock rate of the GPU 300 may be updated, the CP block 325 may determine that the GPU 300 may operate at a different (e.g., a higher or a lower) maximum clock rate based on the first workload type and the current limit. For instance, the CP block 325 may determine that the first workload type of the workload 310-a is a low power-consuming workload type and the CP block 325 may determine that the upper clock rate of the GPU 300 may be increased without exceeding the current limit of the device 105 while processing workload 310-a.

The CP block 325 may signal a first request (e.g., a first interrupt signal) to update the upper clock rate of the GPU 300 based on determining the first workload type. In some implementations, the CP block 325 may signal the first request while the GPU 300 is processing the workload 310-a (e.g., during the first processing operation). In some examples, the CP block 325 may signal the first request to a GMU 330. The GMU 330 may receive the first request and may configure the upper clock rate of the GPU 300 based on the first request from the CP block 325. In some aspects, the GMU 330 may communicate with a power manager 335 to configure the upper clock rate of the GPU 300. For example, in some cases, a request (e.g., an interrupt signal) may be sent from CP block 325 to GMU 330, such that the GMU 330 may update the upper clock rate. In some cases, the first request may include information for updating the upper clock rate (e.g., such as a requested upper clock rate, such as power consumption information on the determined workload type, an identification of the determined workload type, etc.), and the GMU 330 may update the upper clock rate accordingly.

Alternatively, the CP block 325 may update the upper clock rate without signaling the GMU 330. For example, software 320 associated with the GPU 300 may communicate an updated maximum clock rate (e.g., based on the first workload type and the current limit of the device 105) to the CP block 325. In some examples, the CP block 325 may directly configure the upper clock rate of the GPU 300. For instance, the CP block 325 may atomically communicate with the relevant frequency drivers and/or bus drivers of the GPU 300 to configure the upper clock rate of the GPU 300. In such examples, the software 320 may employ a voting mechanism to determine the updated maximum clock rate.

Accordingly, the GPU 300 may process the workload 310-a (e.g., complete the processing operation) based on the configured maximum clock rate of the GPU 300. Once the GPU 300 processes the workload 310-a, the CP block 325 may determine that a second workload 310, such as workload 310-b, is queued for a second (e.g., subsequent) processing operation. In some examples, the second processing operation may be based on a second rendering operation of the GPU 300. For example, the CP block 325 may queue the workload 310-b based on the second rendering operation.

In some examples, the CP block 325 may determine that the workload 310-b is associated with a processing path 340-b and may accordingly determine a power condition (a low power condition, a high power condition, etc.) associated with the workload 310-b. In some aspects, the CP block 325 may determine that the workload 310-b is associated with a second workload type based on determining the power condition of the workload 310-b.

The CP block 325 may signal a second request (e.g., a second interrupt signal) to update the upper clock rate of the GPU 300 based on the workload 310-b being the second workload type. The CP block 325 may signal the second request similarly to how the CP block 325 signaled the first request. For example, the CP block 325 may signal the second request to the GMU 330, and the GMU 330 may configure the upper clock rate of the GPU 300 based on the second request. Additionally or alternatively, the CP block 325 may directly communicate with a frequency driver and/or bus driver of the GPU 300 to configure the upper clock rate of the GPU 300. In some implementations, the CP block 325 may signal the second request while the GPU 300 is processing the workload 310-b.

In some examples, workload 310-b may be associated with a higher power-consuming workload type than workload 310-a and the CP block 325 may request that the upper clock rate of the GPU 300 be reduced (e.g., to stay within the current limits of the device 105 while processing workload 310-b). Accordingly, the GPU 300 may process workload 310-b based on the updated maximum clock rate of the GPU 300.

In some cases, processing paths 340 may include a compute path. For example, the GPU 300 may process compute workloads using the compute path. The compute path may include a number of processing blocks, and the GPU 300 may process compute workloads (e.g., compute operations) using the number of processing blocks included within the compute path. For instance, the compute path may feature a path of processing blocks including a CP block 325/ratio-based burden methodology (RRBM), high level sequencer (HLSQ), stored procedure (SP)/file system (FS) (e.g., a kernel program), level 2 (L2) cache/unified L2 cache (UCHE), system memory, or any combination thereof. The GPU 300 may use the processing blocks included in the compute path to perform the processing operations associated with compute workloads.

Processing paths 340 may further include a visibility path, and the GPU 300 may process visibility pass workloads (e.g., visibility pass operations or binning pass operations) using the visibility path. In some cases, during a binning pass operation, the GPU 300 may construct a visibility stream where visible primitives or draw cells may be identified. The visibility path may include a number of processing blocks, and the GPU 300 may use the number of processing blocks included in the visibility path to perform the processing operations associated with the visibility pass workloads. For instance, the visibility path may feature a path of processing blocks including a CP block 325, vertex fetch decode (VFD), vertex shader (VS), virtual personal computer (VPC)-terminal server edition (TSE)-rasterization (RAS), visibility stream compressor (VSC), L2 cache/UCHE, system memory, or any combination thereof.

Processing paths 340 may also include a render path, and the GPU 300 may process render workloads (e.g., bin-rendering pass in-binning and in-direct rendering operations). In some cases, the render path may be used for rendering pass operations, and a number of primitives in each of a number of bins may be rendered separately. Accordingly, the GPU 300 may process render workloads by repeating the render path based on the number of bins.

For instance, the GPU 300 may render to a bin and perform the draws for the primitives or pixels in the bin. Additionally, the GPU 300 may render to another bin and perform the draws for the primitives or pixels in that bin. Therefore, in some aspects, there may be a small number of bins, e.g., four bins, that cover all of the draws in one surface. Further, the GPU 300 may cycle through all of the draws in one bin, but perform the draws for the draw calls that are visible (e.g., draw calls that include visible geometry). In some aspects, a visibility stream may be generated (e.g., during a binning pass) to determine the visibility information of each primitive in an image or scene. For instance, this visibility stream may identify whether a certain primitive is visible or not. In some aspects, this information may be used to remove primitives that are not visible. In some cases, at least some of the primitives that may be identified as visible may be rendered in the rendering pass.

In some aspects of tiled rendering, there may be multiple processing phases or passes. For instance, the rendering may be performed in two passes (e.g., in a visibility or bin-visibility pass and in a rendering or bin-rendering pass). During a visibility pass, the GPU 300 may input a rendering workload, record the positions of the primitives or triangles, and determine which primitives or triangles fall into which bin or area. In some aspects of a visibility pass, the GPU 300 may identify or mark the visibility of each primitive or triangle in a visibility stream. During a rendering pass, the GPU 300 may input the visibility stream and process one bin or area at a time. In some aspects, the visibility stream may be analyzed to determine which primitives, or vertices of primitives, are visible or not visible. As such, the primitives, or vertices of primitives, that are visible may be processed. By doing so, the GPU 300 may reduce the unnecessary workload of processing or rendering primitives or triangles that are not visible.

In some cases, processing paths 340 may include a 2D path. The GPU 300 may process 2D Blt workloads (e.g., Blt/copy operations) using the 2D path. The 2D path may include a number of processing blocks, and the GPU 300 may use the number of processing blocks of the 2D path to perform the processing operations associated with the 2D Blt workloads. The 2D path may include a CP block 325, VFD, TSE, RAS, transaction processor (TP), render backend (RB), UCHE, SP, or a combination thereof. In some cases, the 2D path may include the SP block in a bypass mode.

The processing paths 340 may also include a resolve path and/or an unresolve path. The GPU may use the resolve path to copy from GMEM to system memory. Alternatively, the GPU 300 may use the unresolve path to copy from the system memory to the GMEM. In some cases, the resolve path and the unresolve path may include a CP block 325, RB, a UCHE block, and a system memory block.

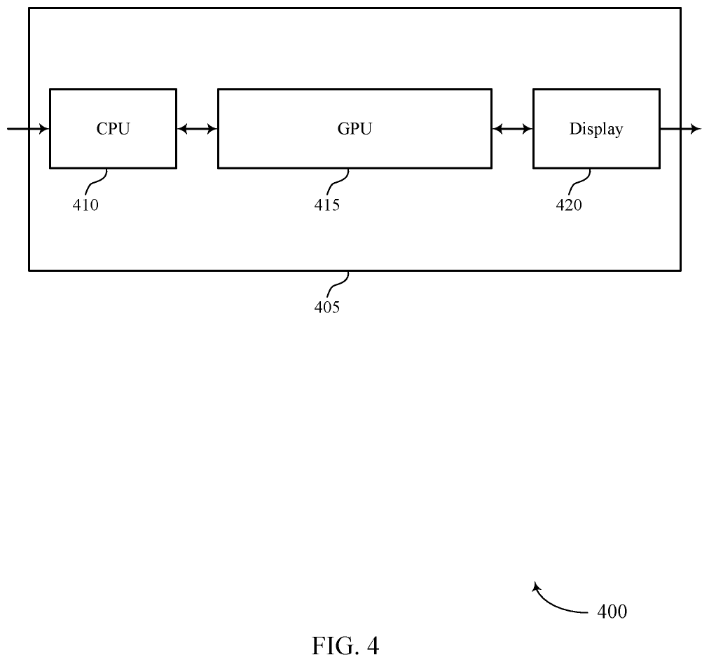

FIG. 4 shows a block diagram 400 of a device 405 that supports higher GPU clocks for low power consuming operations in accordance with aspects of the present disclosure. The device 405 may be an example of aspects of a device 105 or a device 200 as described herein. The device 405 may include a CPU 410, a GPU 415, and a display 420. In some cases, the device 405 may also include a general processor. Each of these components may be in communication with one another (e.g., via one or more buses).

CPU 410 may be an example of CPU 210 described with reference to FIG. 2. CPU 410 may execute one or more software applications, such as web browsers, graphical user interfaces, video games, or other applications involving graphics rendering for image depiction (e.g., via display 420). As described above, CPU 410 may encounter a GPU program (e.g., a program suited for handling by GPU 415) when executing the one or more software applications. Accordingly, CPU 410 may submit rendering commands to GPU 415 (e.g., via a GPU driver containing a compiler for parsing API-based commands).

The GPU 415 may determine, by a command processor block of the GPU, a first workload type for a first processing operation based on a first rendering operation, signal, from the CP block to a GMU, a first request to update an upper clock rate of the GPU based on the determined first workload type, configure, by the GMU, the upper clock rate of the GPU based on the first request, and complete the first processing operation based on the configured upper clock rate of the GPU. The GPU 415 may be an example of aspects of GPUs 225 and 300 described herein.

The GPU 415, or its sub-components, may be implemented in hardware, code (e.g., software or firmware) executed by a processor, or any combination thereof. If implemented in code executed by a processor, the functions of the GPU 415, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The GPU 415, or its sub-components, may be physically located at various positions, including being distributed such that portions of functions are implemented at different physical locations by one or more physical components. In some examples, the GPU 415, or its sub-components, may be a separate and distinct component in accordance with various aspects of the present disclosure. In some examples, the GPU 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Display 420 may display content generated by other components of the device. Display 420 may be an example of display 245 as described with reference to FIG. 2. In some examples, display 420 may be connected with a display buffer which stores rendered data until an image is ready to be displayed (e.g., as described with reference to FIG. 2). The display 420 may illuminate according to signals or information generated by other components of the device 404. For example, the display 420 may receive display information (e.g., pixel mappings, display adjustments) from GPU 415, and may illuminate accordingly. The display 420 may represent a unit capable of displaying video, images, text or any other type of data for consumption by a viewer. Display 420 may include a liquid-crystal display (LCD), a light emitting diode (LED) display, an organic LED (OLED), an active-matrix OLED (AMOLED), or the like. In some cases, display 420 and an I/O controller (e.g., I/O controller 715) may be or represent aspects of a same component (e.g., a touchscreen) of device 405.

The GPU 415 as described herein may be configured to realize one or more potential advantages. One implementation may allow the GPU 415 to process workloads according to faster processing timelines by more efficiently using the power of the device 405. For example, by adaptively updating the upper clock rate of the GPU 415 based on the workload type (e.g., a low power-consuming workload type, a high power-consuming workload type, etc.) and the current limit of the device 405, the GPU 415 may process low power-consuming workload types faster than a traditional GPU that may not implement aspects of the present disclosure.

Based on more efficiently using the power of the device 405 and achieving faster processing timelines, the GPU 415 may spend less time processing, which may increase efficiency of the device 405 and enable the device 405 to have more time for other operations. Moreover, faster processing timelines may result in improved user experience. For example, the GPU 415 may achieve faster processing timelines and may output to a display 420 more frequently and/or with better quality.

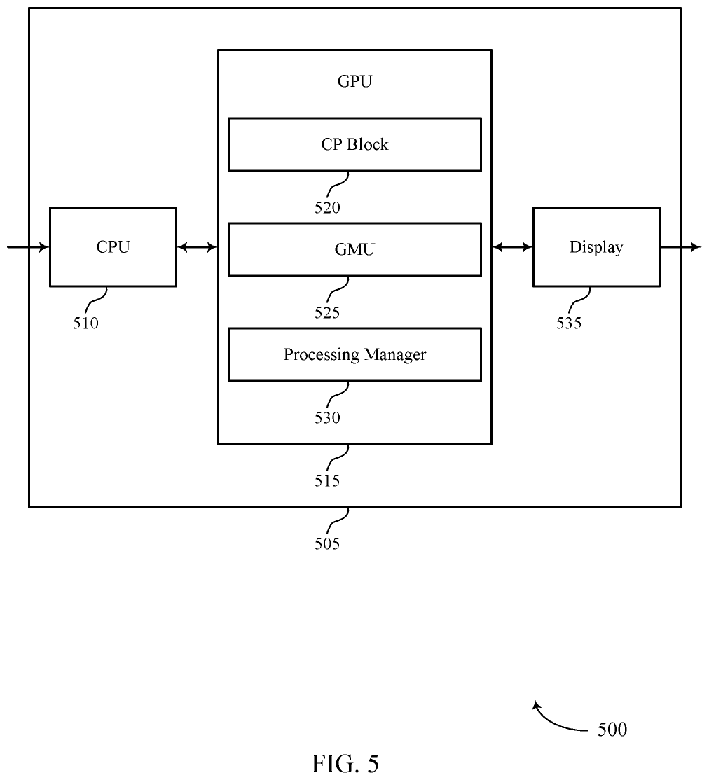

FIG. 5 shows a block diagram 500 of a device 505 that supports higher GPU clocks for low power consuming operations in accordance with aspects of the present disclosure. The device 505 may be an example of aspects of a device 105, a device 200, or a device 505 as described herein. The device 505 may include a CPU 510, a GPU 515, and a display 535. The device 505 may also include a processor. Each of these components may be in communication with one another (e.g., via one or more buses). The GPU 515 may be an example of aspects of a GPU 225, a GPU 300, or a GPU 415 as described herein. The GPU 515 may include a CP block 520, a GMU 525, and a processing manager 530.

CPU 510 may be an example of CPU 210 described with reference to FIG. 2. CPU 510 may execute one or more software applications, such as web browsers, graphical user interfaces, video games, or other applications involving graphics rendering for image depiction (e.g., via display 535). As described above, CPU 510 may encounter a GPU program (e.g., a program suited for handling by GPU 515) when executing the one or more software applications. Accordingly, CPU 510 may submit rendering commands to GPU 515 (e.g., via a GPU driver containing a compiler for parsing API-based commands).

The CP block 520 may determine a first workload type for a first processing operation based on a first rendering operation and signal, to the GMU 525, a first request to update an upper clock rate of the GPU 515 based on the determined first workload type. The GMU 525 may configure the upper clock rate of the GPU 515 based on the first request. The processing manager 530 may complete the first processing operation based on the configured upper clock rate of the GPU 515.

Display 535 may display content generated by other components of the device. Display 535 may be an example of display 245 as described with reference to FIG. 2. In some examples, display 535 may be connected with a display buffer which stores rendered data until an image is ready to be displayed (e.g., as described with reference to FIG. 2). The display 535 may illuminate according to signals or information generated by other components of the device 505. For example, the display 535 may receive display information (e.g., pixel mappings, display adjustments) from GPU 515, and may illuminate accordingly. The display 535 may represent a unit capable of displaying video, images, text or any other type of data for consumption by a viewer. Display 535 may include a liquid-crystal display (LCD), a light emitting diode (LED) display, an organic LED (OLED), an active-matrix OLED (AMOLED), or the like. In some cases, display 535 and an I/O controller (e.g., I/O controller 715) may be or represent aspects of a same component (e.g., a touchscreen) of device 505.

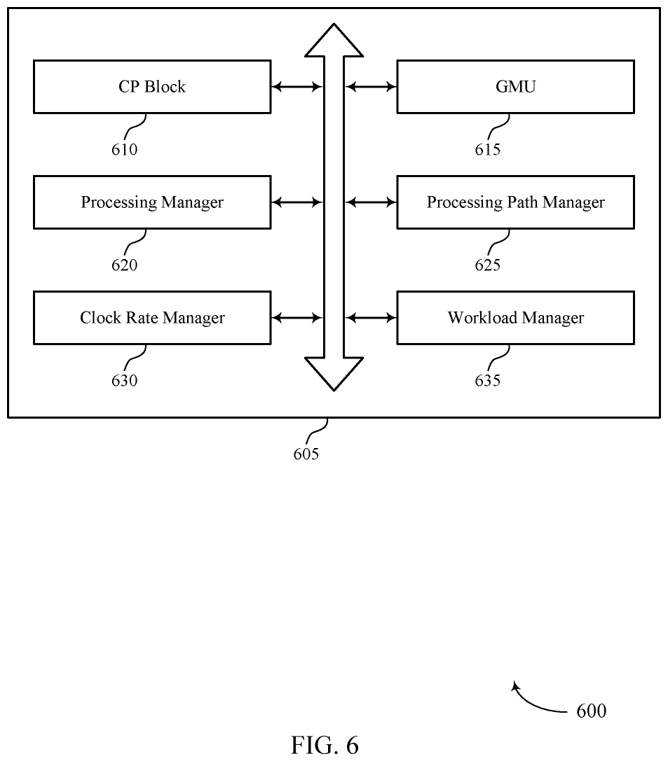

FIG. 6 shows a block diagram 600 of a GPU 605 that supports higher GPU clocks for low power consuming operations in accordance with aspects of the present disclosure. The GPU 605 may be an example of aspects of a GPU 225, a GPU 300, a GPU 415, or a GPU 515 described herein. The GPU 605 may include a CP block 610, a GMU 615, a processing manager 620, a processing path manager 625, a clock rate manager 630, and a workload manager 635. Each of these modules may communicate, directly or indirectly, with one another (e.g., via one or more buses).

The CP block 610 may determine a first workload type for a first processing operation based on a first rendering operation. In some examples, the CP block 610 may signal, to the GMU 615, a first request to update an upper clock rate of the GPU 605 based on the determined first workload type. In some examples, the CP block 610 may determine a second workload type for a second processing operation based on a second rendering operation. In some examples, the CP block 610 may signal a second request to update the upper clock rate of the GPU 605 based on the second workload type and the completion of the first processing operation. In some cases, the first request is signaled during the first processing operation of the first workload type.

The GMU 615 may configure the upper clock rate of the GPU 605 based on the first request. In some examples, the GMU 615 may configure the upper clock rate of the GPU 605 based on the second request. The processing manager 620 may complete the first processing operation based on the configured upper clock rate of the GPU 605. In some examples, determining that the first workload type is associated with a power condition that is below a threshold, where the first request includes an indication to increase the upper clock rate of the GPU 605 based on the determination that the first workload type is associated with the power condition.

The processing path manager 625 may determine one or more paths for the first processing operation based on the determined first workload type, where the upper clock rate of the GPU 605 is configured based on the one or more paths for the first processing operation. In some examples, the processing path manager 625 may determine one or more paths for the second processing operation based on the second workload type, where the upper clock rate of the GPU 605 is updated based on the one or more paths for the second processing operation. In some cases, the upper clock rate of the GPU 605 is configured based on one or more processing blocks associated with the one or more paths for the first processing operation.

The clock rate manager 630 may increase the upper clock rate of the GPU 605 based on the first workload type for the first processing operation, where the first processing operation is completed based on the increased upper clock rate. In some examples, the clock rate manager 630 may determine the upper clock rate of the GPU 605 based on the first workload type and a power condition of the device. In some examples, the clock rate manager 630 may reduce the upper clock rate of the GPU 605 based on the second workload type. The workload manager 635 may queue a first workload batch for the first processing operation, where the first request includes an interrupt signal to request the GMU 615 to update the upper clock rate of the GPU 605 based on the queued first workload batch. In some cases, the first workload type is determined based on the first workload batch. In some cases, the queuing is based on the first rendering operation.

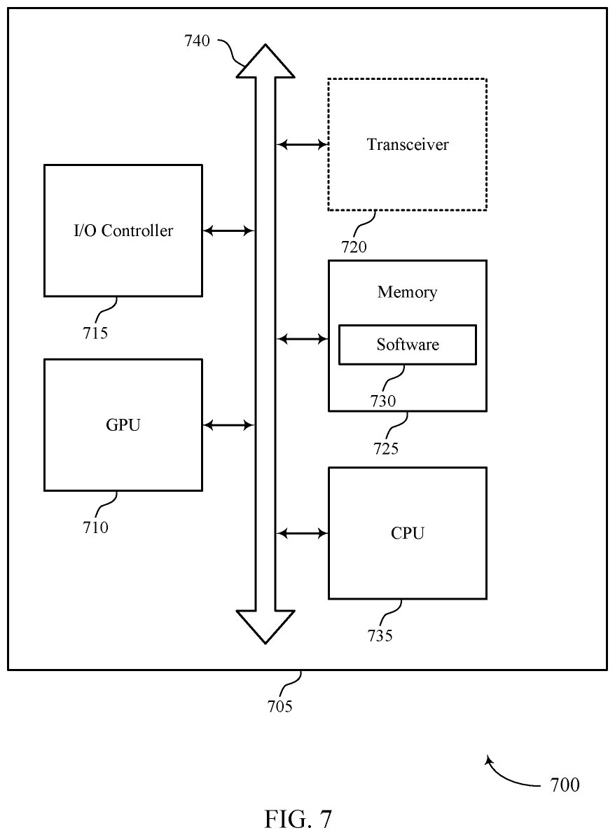

FIG. 7 shows a diagram of a system 700 including a device 705 that supports higher GPU clocks for low power consuming operations in accordance with aspects of the present disclosure. The device 705 may be an example of or include the components of device 105 as described herein. The device 705 may include components for bi-directional voice and data communications including components for transmitting and receiving communications, including a GPU 710, an I/O controller 715, a transceiver 720, memory 725, software 730, and a CPU 735. These components may be in electronic communication via one or more buses (e.g., bus 740).

The GPU 710 may determine, by a CP block of the GPU 710, a first workload type for a first processing operation based on a first rendering operation, signal, from the CP block to a GMU, a first request to update an upper clock rate of the GPU 710 based on the determined first workload type, configure, by the GMU, the upper clock rate of the GPU 710 based on the first request, and complete the first processing operation based on the configured upper clock rate of the GPU 710.

CPU 735 may include an intelligent hardware device, (e.g., a general-purpose processor, a DSP, a microcontroller, an ASIC, an FPGA, a programmable logic device, a discrete gate or transistor logic component, a discrete hardware component, or any combination thereof). In some cases, CPU 735 may be configured to operate a memory array using a memory controller. In other cases, a memory controller may be integrated into CPU 735. CPU 735 may be configured to execute computer-readable instructions stored in a memory to perform various functions (e.g., functions or tasks supporting dynamic bin ordering for load synchronization).

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715. In some cases the I/O controller 715 may control or include a display.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

The memory 725 may include RAM and ROM. The memory 725 may store computer-readable, computer-executable code or software 730 including instructions that, when executed, cause the processor to perform various functions described herein. In some cases, the memory 725 may contain, among other things, a BIOS which may control basic hardware or software operation such as the interaction with peripheral components or devices.

In some cases, the GPU 710 and/or the CPU 735 may include an intelligent hardware device, (e.g., a general-purpose processor, a DSP, a microcontroller, an ASIC, an FPGA, a programmable logic device, a discrete gate or transistor logic component, a discrete hardware component, or any combination thereof). In some cases, the GPU 710 and/or the CPU 735 may be configured to operate a memory array using a memory controller. In other cases, a memory controller may be integrated into the GPU 710 and/or the CPU 735. The GPU 710 and/or the CPU 735 may be configured to execute computer-readable instructions stored in a memory (e.g., the memory 725) to cause the device 705 to perform various functions (e.g., functions or tasks supporting higher GPU clocks for low power consuming operations).

The software 730 may include instructions to implement aspects of the present disclosure, including instructions to support image processing at a device. The software 730 may be stored in a non-transitory computer-readable medium such as system memory or other type of memory. In some cases, the software 730 may not be directly executable by the CPU 735 but may cause a computer (e.g., when compiled and executed) to perform functions described herein.

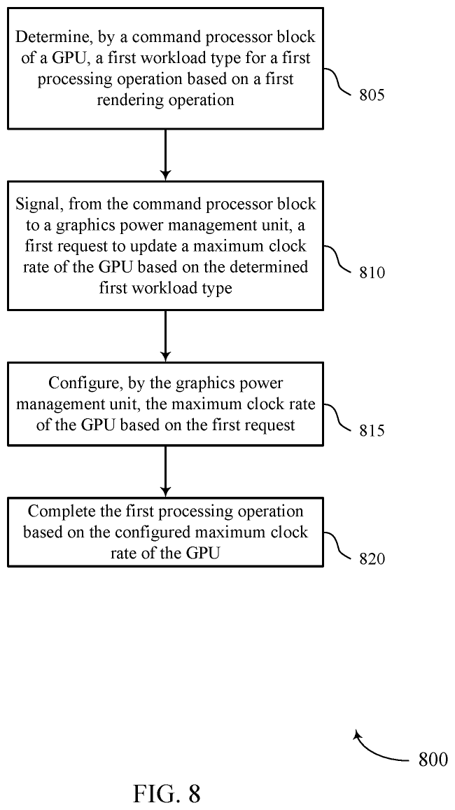

FIG. 8 shows a flowchart illustrating a method 800 that supports higher GPU clocks for low power consuming operations in accordance with aspects of the present disclosure. The operations of method 800 may be implemented by a device or its components as described herein. For example, the operations of method 800 may be performed by a GPU as described with reference to FIGS. 2 through 7. In some examples, a device may execute a set of instructions to control the functional elements of the device to perform the functions described below. Additionally or alternatively, a device may perform aspects of the functions described below using special-purpose hardware.

At 805, the device may determine, by a CP block of a GPU, a first workload type for a first processing operation based on a first rendering operation. The operations of 805 may be performed according to the methods described herein. In some examples, aspects of the operations of 805 may be performed by a CP block as described with reference to FIGS. 3 through 6.

At 810, the device may signal, from the CP block to a GMU, a first request to update an upper clock rate of the GPU based on the determined first workload type. The operations of 810 may be performed according to the methods described herein. In some examples, aspects of the operations of 810 may be performed by a CP block as described with reference to FIGS. 3 through 6.

At 815, the device may configure, by the GMU, the upper clock rate of the GPU based on the first request. The operations of 815 may be performed according to the methods described herein. In some examples, aspects of the operations of 815 may be performed by a GMU as described with reference to FIGS. 3 through 6.

At 820, the device may complete the first processing operation based on the configured upper clock rate of the GPU. The operations of 820 may be performed according to the methods described herein. In some examples, aspects of the operations of 820 may be performed by a processing manager as described with reference to FIGS. 5 through 6.

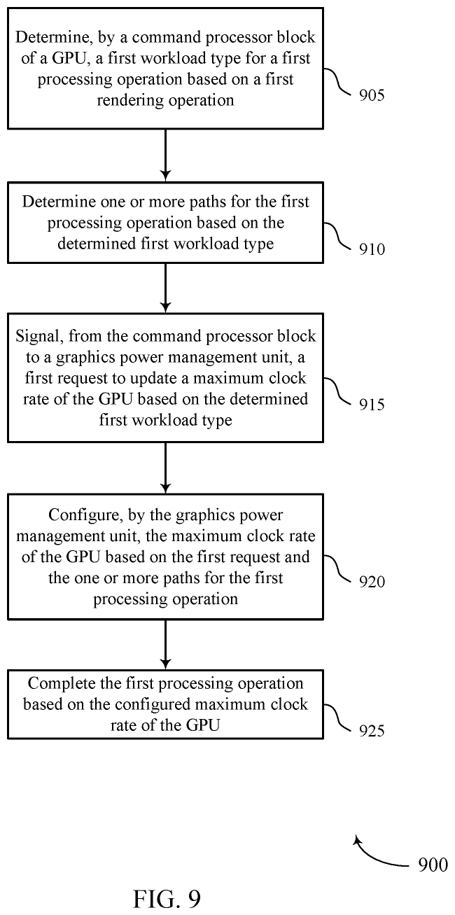

FIG. 9 shows a flowchart illustrating a method 900 that supports higher GPU clocks for low power consuming operations in accordance with aspects of the present disclosure. The operations of method 900 may be implemented by a device or its components as described herein. For example, the operations of method 900 may be performed by a GPU as described with reference to FIGS. 2 through 7. In some examples, a device may execute a set of instructions to control the functional elements of the device to perform the functions described below. Additionally or alternatively, a device may perform aspects of the functions described below using special-purpose hardware.

At 905, the device may determine, by a CP block of a GPU, a first workload type for a first processing operation based on a first rendering operation. The operations of 905 may be performed according to the methods described herein. In some examples, aspects of the operations of 905 may be performed by a CP block as described with reference to FIGS. 3 through 6.

At 910, the device may determine one or more paths for the first processing operation based on the determined first workload type. The operations of 910 may be performed according to the methods described herein. In some examples, aspects of the operations of 910 may be performed by a processing path manager as described with reference to FIG. 6.

At 915, the device may signal, from the CP block to a GMU, a first request to update an upper clock rate of the GPU based on the determined first workload type. The operations of 915 may be performed according to the methods described herein. In some examples, aspects of the operations of 915 may be performed by a CP block as described with reference to FIGS. 3 through 6.

At 920, the device may configure, by the GMU, the upper clock rate of the GPU based on the first request and the one or more paths for the first processing operation. The operations of 920 may be performed according to the methods described herein. In some examples, aspects of the operations of 920 may be performed by a GMU as described with reference to FIGS. 3 through 6.

At 925, the device may complete the first processing operation based on the configured upper clock rate of the GPU. The operations of 925 may be performed according to the methods described herein. In some examples, aspects of the operations of 925 may be performed by a processing manager as described with reference to FIGS. 5 through 6.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for processing at a device, comprising:
determining, by a command processor block of a graphics processing unit (GPU), a first workload type for a first processing operation based at least in part on a first rendering operation;
signaling, from the command processor block to a graphics power management unit, a first request to update an upper clock rate of the GPU based at least in part on the determined first workload type;
configuring, by the graphics power management unit, the upper clock rate of the GPU based at least in part on the first request; and
completing the first processing operation based at least in part on the configured upper clock rate of the GPU.

2. The method of claim 1, further comprising:
determining one or more paths for the first processing operation based at least in part on the determined first workload type, wherein the upper clock rate of the GPU is configured based at least in part on the one or more paths for the first processing operation.

3. The method of claim 2, wherein the upper clock rate of the GPU is configured based at least in part on one or more processing blocks associated with the one or more paths for the first processing operation.

4. The method of claim 1, wherein configuring the upper clock rate of the GPU based at least in part on the first request comprises:
increasing the upper clock rate of the GPU based at least in part on the first workload type for the first processing operation, wherein the first processing operation is completed based at least in part on the increased upper clock rate.

5. The method of claim 1, further comprising:
determining, by the graphics power management unit, the upper clock rate of the GPU based at least in part on the first workload type and a power condition of the device.

6. The method of claim 1, wherein the first request is signaled during the first processing operation of the first workload type.

7. The method of claim 1, further comprising:
determining, by the command processor block of the GPU, a second workload type for a second processing operation based at least in part on a second rendering operation;
signaling a second request to update the upper clock rate of the GPU based at least in part on the second workload type and the completion of the first processing operation; and
configuring, by the graphics power management unit, the upper clock rate of the GPU based at least in part on the second request.

8. The method of claim 7, further comprising:
determining one or more paths for the second processing operation based at least in part on the second workload type, wherein the upper clock rate of the GPU is updated based at least in part on the one or more paths for the second processing operation.

9. The method of claim 7, wherein configuring the upper clock rate of the GPU based at least in part on the second request comprises:
reducing the upper clock rate of the GPU based at least in part on the second workload type.

10. The method of claim 1, further comprising:
queuing a first workload batch for the first processing operation, wherein the first request comprises an interrupt signal to request the graphics power management unit to update the upper clock rate of the GPU based at least in part on the queued first workload batch.

11. The method of claim 10, wherein the first workload type is determined based on the first workload batch.

12. The method of claim 10, wherein the queuing is based at least in part on the first rendering operation.

13. The method of claim 1, further comprising:
determining that the first workload type is associated with a power condition that is below a threshold, wherein the first request comprises an indication to increase the upper clock rate of the GPU based at least in part on the determination that the first workload type is associated with the power condition.

14. An apparatus for processing at a device, comprising:
a processor,
memory coupled with the processor; and
instructions stored in the memory and executable by the processor to cause the apparatus to:
determine, by a command processor block of a graphics processing unit (GPU), a first workload type for a first processing operation based at least in part on a first rendering operation;
signal, from the command processor block to a graphics power management unit, a first request to update an upper clock rate of the GPU based at least in part on the determined first workload type;
configure, by the graphics power management unit, the upper clock rate of the GPU based at least in part on the first request; and
complete the first processing operation based at least in part on the configured upper clock rate of the GPU.

15. The apparatus of claim 14, wherein the instructions are further executable by the processor to cause the apparatus to:
determine one or more paths for the first processing operation based at least in part on the determined first workload type, wherein the upper clock rate of the GPU is configured based at least in part on the one or more paths for the first processing operation.

16. The apparatus of claim 15, wherein the upper clock rate of the GPU is configured based at least in part on one or more processing blocks associated with the one or more paths for the first processing operation.

17. The apparatus of claim 14, wherein the instructions to configure the upper clock rate of the GPU based at least in part on the first request are executable by the processor to cause the apparatus to:
increase the upper clock rate of the GPU based at least in part on the first workload type for the first processing operation, wherein the first processing operation is completed based at least in part on the increased upper clock rate.

18. The apparatus of claim 14, wherein the instructions are further executable by the processor to cause the apparatus to:
determine, by the graphics power management unit, the upper clock rate of the GPU based at least in part on the first workload type and a power condition of the device.

19. The apparatus of claim 14, wherein the instructions are further executable by the processor to cause the apparatus to:
determine, by the command processor block of the GPU, a second workload type for a second processing operation based at least in part on a second rendering operation;
signal a second request to update the upper clock rate of the GPU based at least in part on the second workload type and the completion of the first processing operation; and
configure, by the graphics power management unit, the upper clock rate of the GPU based at least in part on the second request.

20. An apparatus for processing at a device, comprising:
means for determining, by a command processor block of a graphics processing unit (GPU), a first workload type for a first processing operation based at least in part on a first rendering operation;
means for signaling, from the command processor block to a graphics power management unit, a first request to update an upper clock rate of the GPU based at least in part on the determined first workload type;
means for configuring, by the graphics power management unit, the upper clock rate of the GPU based at least in part on the first request; and
means for completing the first processing operation based at least in part on the configured upper clock rate of the GPU.
